(19) United States
(12) Patent Application Publication
(10) Pub. No.: US 2011/0232580 A1
(43) Pub. Date: Sep. 29, 2011

(54) Pet toy and method for making the same

(75) Inventor: Jack W. Renforth, Rose Hill, KS (US)

(73) Assignee: Rose America Corporation

(21) Appl. No.: 12/659,876

(22) Filed: Mar. 24, 2010

(51) Int. Cl. A01K 15/00; B23P 11/00

(52) U.S. Cl. 119/707; 29/428

(57) ABSTRACT

A pet toy includes a length of a plurality of composite strands twisted about each other and first and second knots. Each strand includes an inner core of natural fibers encased in a fabric layer, such as denim.

### FIELD AND BACKGROUND OF THE INVENTION

The present invention is generally directed to animal or pet accessories, and more particularly to a pet toy and method for making the same.

When interacting with animals or pets for training, educational, playful, or other purposes, owners and handlers use various toys or devices. It is desirable that these toys and devices not only be durable and render the intended objective or function, but also provide a health benefit and be satisfying to the animal.

Various pet toys or devices are available in the prior art, as shown in U.S. Pat. Nos. 1,149,170; 4,513,014; 4,557,219; 5,215,038; 5,329,881; 5,467,741; 5,477,815; 5,560,320; 5,682,838; 5,711,254; 6,014,950; 6,178,922; 6,283,063; 6,918,355; 7,144,293; 7,207,294; 2006/0090709; 2009/0025648; and 2009/0114167.

### ASPECTS OF THE INVENTION

The present disclosure is directed to various aspects of the present invention.

One aspect of the present invention includes an animal or pet toy which is durable and does not deteriorate easily.

Another aspect of the present invention includes an animal or pet toy which provides extended periods of chewing satisfaction without deterioration.

Another aspect of the present invention includes an animal or pet toy which provides dental benefits in keeping a pet's teeth free of tartar.

Another aspect of the present invention includes an animal or pet toy which is long lasting and provides enhanced or additional interactivity between the pet and its handler or owner.

Another aspect of the present invention includes a pet toy including a length of a plurality of composite strands twisted about each other and first and second knots. Each strand includes an inner core of natural fibers encased in a fabric layer. The end portions are untwisted.

Another aspect of the present invention includes a pet toy including a length of composite strands twisted about each other in a rope configuration and first and second knots. Each strand includes an inner core of natural fibers encased in a woven cotton layer. The end portions are untwisted.

Another aspect of the present invention includes a pet toy including a length of composite strands twisted about each other and first and second knots adjacent the first and second end portions thereof. The length is folded about a fold point such that the first and second end portions lie adjacent each other and away from the fold point. Each strand includes an inner core of natural fibers encased in a fabric layer.

Another aspect of the present invention includes a method of forming a toy, which includes forming a composite strand by encasing a plurality of natural fibers in a fabric layer, and twisting a plurality of the composite strands about each other so as to form an elongated composite piece.

### BRIEF DESCRIPTION OF THE DRAWINGS

One of the above and other aspects, novel features and advantages of the present invention will become apparent from the following detailed description of a preferred embodiment(s) of the invention, as illustrated in the drawings, in which:

FIG. 1 is a perspective view of a pet toy in accordance with a first embodiment of the present invention;

FIG. 2 is a perspective view of a pet toy in accordance with a second embodiment of the present invention;

FIG. 3 is a perspective view of a pet toy in accordance with a third embodiment of the present invention;

FIG. 4 is a perspective view of a composite strand in accordance with an embodiment of the present invention that is used to form a pet in accordance with an embodiment of the present invention;

FIG. 5 is an enlarged cross-sectional view taken along line 5-5 of FIG. 4;

FIG. 6 is an enlarged cross-sectional view taken along line 6-6 of FIG. 1; and

It is noted herewith that like reference numerals have been used to designate the similar components in various embodiments.

### DETAILED DESCRIPTION OF THE PREFERRED EMBODIMENT(S) OF THE INVENTION

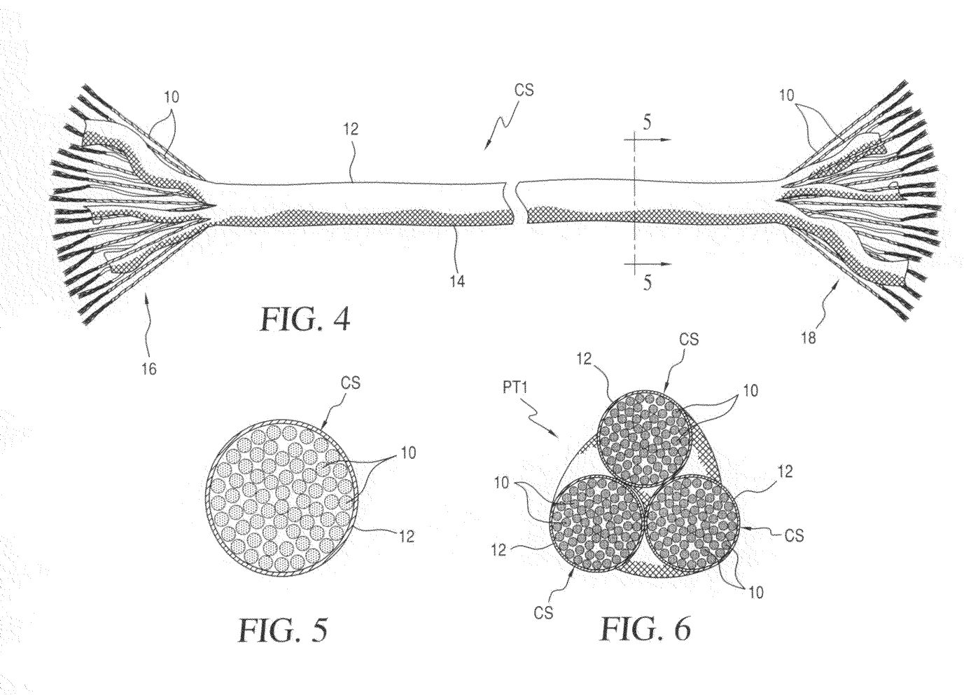

As best shown in FIGS. 4-5, a composite strand CS, in accordance with an embodiment of the present invention, includes natural fibers 10 encased or wrapped in a fabric layer 12. Preferably, the natural fibers 10 include sisal fibers and the fabric layer 12 is made of a woven cotton material, such as denim. It is noted herewith that other types of woven material may also be used as the external fabric layer 12.

The composite strand CS is constructed in a manner that while its intermediate portion 14 substantially or entirely encases or wraps around the natural fibers 10, the end portions 16 and 18 thereof are frayed so that the fibers 10 are exposed, along with the fabric. The natural fibers 10 not only provide a crunchy satisfying sound, but also render a dental benefit in keeping a pet, such as a dog's teeth substantially free of tartar or other undesirable deposit. The fabric layer 12 helps to maintain the shape of the toy, as well as renders a texture that would be appealing and satisfying to a pet.

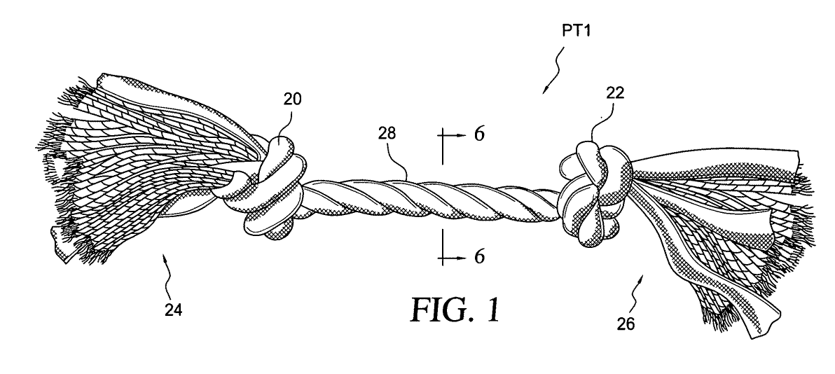

Referring to FIGS. 1-3, various preferred embodiments of the pet toy of the present invention, made by using the composite strand CS, will now be described.

As shown in FIGS. 1 and 6, the pet toy PT1, includes preferably three composite strands CS twisted about each other to form a dog bone configuration, which includes end knots 20 and 22, adjacent the free end portions 24 and 26, respectively. Preferably, the end portions 24 and 26 are untwisted and/or frayed, while the intermediate portion 28 is substantially or completely twisted.

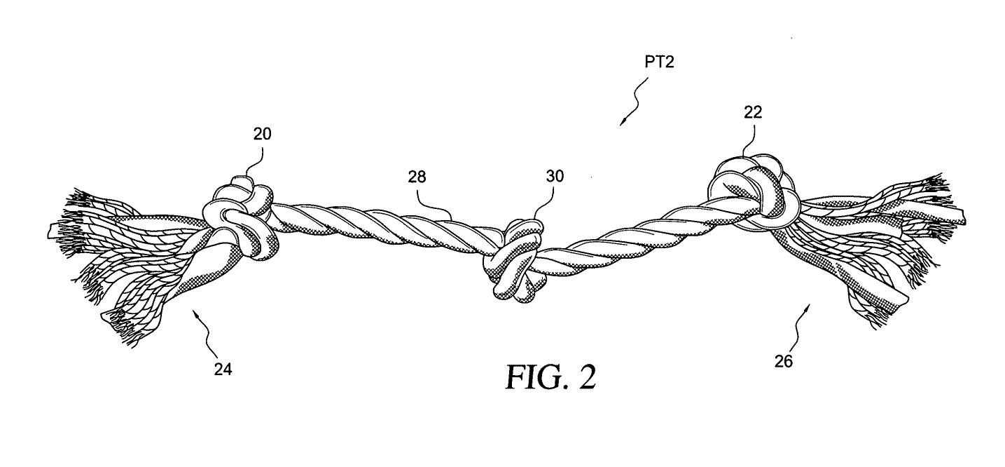

FIG. 2 illustrates a second embodiment of pet toy PT2 of the present invention, which is identical to the embodiment shown in FIG. 1, with the exception that a third knot 30 is provided in the intermediate portion 28.

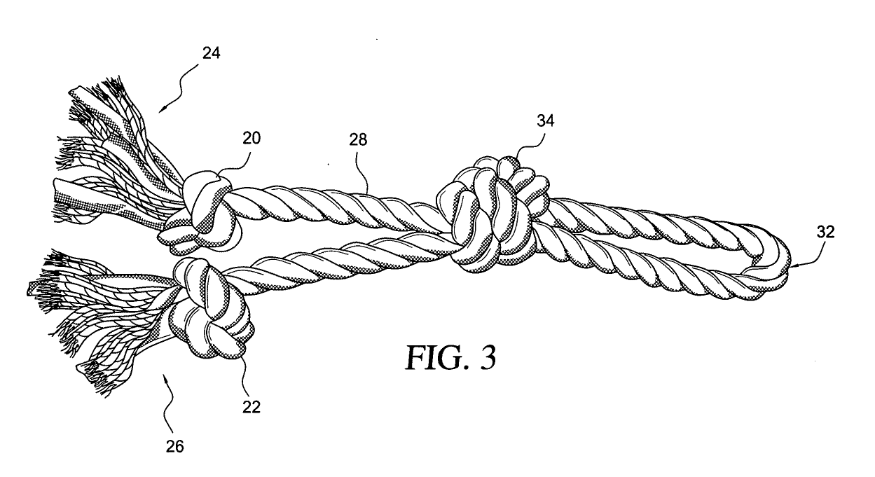

FIG. 3 illustrates a third embodiment of the pet toy PT3 of the present invention, which is similar to the embodiment shown in FIG. 1, with the exception that the intermediate portion 28 is bent or folded onto itself at a fold point 32, in a manner that the end portions 24 and 26 come to lie adjacent each other and away or opposite the fold point 32. Preferably, the fold point 32 lies about mid-way on the length of the intermediate portion 28. Once folded in this manner, a third knot 34 is provided that lies between the end portions 24 and 26 and the fold point 32. The provision of the third knot 34 and the fold point 32 renders a loop 36, which can be grasped by a user when interacting with a pet, such as a dog.

Although it is preferred that the diameter of the composite strand CS be kept from about one-half inch to one inch, it is within the scope of this invention to make smaller or larger diameter composite strands, as desired. Likewise, although it is preferred that the natural fibers be tightly packed or encased in the fabric layer 12, the quantity or density thereof can be varied, as desired.

While this invention has been described as having preferred sequences, ranges, steps, materials, structures, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention.

What is claimed is:

1. A pet toy, comprising:
a) a length of a plurality of composite strands twisted about each other and including first and second knots;
b) each of said strands comprising an inner core encased in a fabric layer;
c) said inner core comprising a plurality of natural fibers; and
d) said length including untwisted end portions.

2. The toy of claim 1, wherein:
a) said fabric layer comprises a woven cotton material.

3. The toy of claim 1, wherein:
a) said fabric layer comprises denim material.

4. The toy of claim 3, wherein:
a) said natural fibers comprise sisal fibers.

5. The toy of claim 1, wherein:
a) the end portions are frayed.

6. The toy of claim 1, wherein:
a) said length includes a third knot between said first and second knots.

7. The toy of claim 1, wherein:
a) the natural fibers are exposed to the exterior only in the end portions of said length.

8. The toy of claim 4, wherein:
a) at least one of said strands has a diameter of about ½ to about 1 inch.

9. A pet toy, comprising:
a) a length of a plurality of composite strands twisted about each other in a rope configuration and including first and second knots;
b) each of said strands comprising an inner core encased in a woven cotton layer;
c) said inner core comprising a plurality of natural fibers; and
d) said length including untwisted end portions.

10. The toy of claim 9, wherein:
a) said cotton layer comprises denim material.

11. The toy of claim 9, wherein:
a) said natural fibers comprise sisal fibers.

12. The toy of claim 9, wherein:
a) the end portions are frayed.

13. The toy of claim 9, wherein:
a) said length includes a third knot between said first and second knots.

14. The toy of claim 9, wherein:
a) the natural fibers are exposed to the exterior only in the end portions of said length.

15. The toy of claim 11, wherein:
a) at least one of said strands has a diameter of about 1/2 to about 1 inch.

16. A pet toy, comprising:
a) a length of a plurality of composite strands twisted about each other and including first and second knots adjacent first and second end portions of said length;
b) said length being folded about a fold point such that said first and second end portions thereof lie adjacent each other and away from the fold point;
c) each of said strands comprising an inner core encased in a fabric layer; and
c) said inner core comprising a plurality of natural fibers.

17. The toy of claim 16, wherein:
a) said fabric layer comprises a woven cotton material.

18. The toy of claim 16, wherein:
a) said fabric comprises denim material.

19. The toy of claim 16, wherein:
a) said natural fibers comprise sisal fibers.

20. A toy of claim 16, wherein:
a) said first and second end portions are untwisted.

21. A toy of claim 16, wherein:
a) said length includes a third knot between said fold point and said first and second end portions.

22. A method of forming a pet toy, comprising the steps of:
a) forming a composite strand by encasing a plurality of natural fibers in a fabric layer; and
b) twisting a plurality of the composite strands about each other so as to form an elongated composite piece.

23. The method of claim 22, further comprising the step of:
c) cutting the elongated composite piece to form a desired length and providing first and second knots adjacent the respective end portions thereof.

24. The method of claim 23, wherein:
the end portions are untwisted and the fabric layer comprises denim material.

25. The method of claim 24, wherein:
the natural fibers comprise sisal fibers.

26. The method of claim 23, further comprising the step of:
d) providing a third knot between the first and second knots.

27. The method of claim 26, wherein:
the end portions are untwisted and the fabric layer comprises denim material.

28. The method of claim 23, further comprising the steps of:
d) folding the length of the composite piece about a fold point in a manner that the first and second knots lie adjacent each other and away from the fold point; and
e) providing a third knot between the fold point and the first and second knots.

29. The method of claim 28, wherein:
the end portions are untwisted and the fabric layer comprises denim material.
